(19) United States
(12) Patent Application Publication
(10) Pub. No.: US 2006/0085806 A1
(43) Pub. Date: Apr. 20, 2006

(54) Fastening mechanism and disk changer device with fastening mechanism

(75) Inventor: Jui-Chiang Lin, Hsinchu City (TW)

Correspondence Address: BRUCE H. TROXELL, SUITE 1404, 5205 LEESBURG PIKE, FALLS CHURCH, VA, 22041, US

(73) Assignee: LITE-ON IT CORPORATION

(21) Appl. No.: 11/249,486

(22) Filed: Oct. 14, 2005

(30) Foreign Application Priority Data
Oct. 19, 2004 (TW) 93131697

(51) Int. Cl. G11B 17/04

(52) U.S. Cl. 720/619

(57) ABSTRACT

A disk changer includes a magazine and a handling mechanism, the magazine includes a plurality of disk holding member. The handling mechanism includes a drafting unit, an elevating unit and an optical pick-up unit. The elevating unit is used to vertically move the drafting unit and the optical pick-up unit to a predetermined position corresponding to a predetermined disk holding member. The drafting unit is used to horizontally draft the predetermined disk holding member to make the disk on the predetermined disk holding member ready to be accessed by the optical pick-up unit, wherein the predetermined disk holding member is draft following a guiding track. In the present invention, one portion of the guiding track is installed within the magazine, the other portion of the guiding track is installed in the optical pick-up unit. The fastening mechanism includes an elastic mechanism installed on left and right sections of the guiding track, wherein the elastic mechanism elastically pushes against corresponding right and left edges of the predetermined disk holding member as long as the predetermined disk holding member is within the guiding track, thus prevent it from shocking.

### BACKGROUND OF THE INVENTION

(1) Field of the Invention

The invention relates to a disk changer device, and more particularly to the disk changer device using fastening mechanism for lodging the disk therein.

(2) Description of the Prior Art

Because the cost of the optical accessible media, such as optical disk or compact disk (CD), is very low, and it is very easy as well as convenient to manipulate the optical drive to access the data from the optical disk. Accordingly, the optical drive that can read/write date from/to the optical drive is much more popular than ever.

As we usually see on the market, the optical drive is used to read the data from only one optical disk, and the user has to extract the inside disk and then insert the new one by hand. When it comes to car stereo, the audio CD receiver can perform as an audio CD player, thus a car-based product for automatically changing disks is presented. Because of the present of the disk changer, the disks in the car stereo can be changed automatically, thus it is very convenient for the user in the vehicle to use the car stereo.

As shown in FIG. 1, the disk changer 2 in the prior art includes a magazine 4 and a handling mechanism 6, wherein the magazine 4 includes a plurality of disk holding member 402, besides, the handling unit 6 includes a drafting unit 602, an elevating unit 604, and an optical pick-up unit 606. The three units mentioned above are mechanically coupled, in detail, the elevating unit 604 are loaded with the drafting unit 602 and the optical pick-up unit 606.

When the elevating unit 604 vertically move to a predetermined position responding to one of the plurality of disk holding member 402, then the drafting unit 602 horizontally draft the predetermined disk holding member 402 to a position corresponding to the optical pick-up unit 606, and the disk 8 on the predetermined disk holding member 402 is ready to be accessed by the optical pick-up unit 606. Specifically, when the predetermined disk holding member 402 is driven by the drafting unit 602, the right and/or left edge of the predetermined disk holding member 402 is adopted in and confined to move within the track of the magazine 4 and the optical pick-up unit 606, which is referred to as guiding track.

When the predetermined disk holding member 402 is driven to move in the guiding track, either the common difference among the mechanisms or any quake will make the predetermined disk holding member 402 shake to the left or to the right. Thus the interior surface of the side-walls, including the side-walls of the magazine 4 and the optical pick-up unit 606. According to the CD player in the car stereo as well as in the portable device in the prior art, this kind of quake is inevitable, and the collision mentioned above always happen.

Thus it is very important to propose a disk changer with fastening mechanism to overcome the problems mentioned above.

### SUMMARY OF THE INVENTION

An object of the present invention is to provide a fastening mechanism in a disk changing device, such as a multi-disc changer installed a car, which can be used to cooperate with a car-based stereo. With the fastening mechanism, the part of the disk holding device which holding the disk will be firmly held, and the shake is prevented even if the vehicle is in motion on a bumpy road.

The other object of the present invention is to fix the part holding the disk to predetermined position, and to prevent the part from shocking no matter when the part is stationary or in motion.

A disk changer device at least includes a magazine and a handling mechanism, the magazine at least includes a plurality of disk holding member. The handling mechanism at least includes a drafting unit, an elevating unit and an optical pick-up unit. The elevating unit is loaded with the drafting unit and the optical pick-up unit, wherein the elevating unit is used to vertically move the drafting unit and the optical pick-up unit to a predetermined position corresponding to a predetermined disk holding member from a plurality of disk holding member. The drafting unit is used to horizontally draft the predetermined disk holding member to a position corresponding to the optical pick-up unit, and then a disk on the predetermined disk holding member is ready to be accessed by the optical pick-up unit, wherein the predetermined disk holding member is draft following a guiding track. In other words, the disk holding member is adopted in and confined to the guiding track, and the drafting unit can only drive the disk holding member following in the direction of the guiding track.

The elastic mechanism is installed on left and right section of the guiding track, wherein the elastic mechanism elastically push against corresponding right and left edge of the predetermined disk holding member as long as the predetermined disk holding member being within the guiding track. In the present invention, one portion of the guiding track is installed within the magazine, the other portion of the guiding track is installed in the optical pick-up unit.

The fastening mechanism at least includes an elastic mechanism installed on left and right sections of the guiding track, wherein the elastic mechanism elastically pushes against corresponding right and left edges of the predetermined disk holding member as long as the predetermined disk holding member is within the guiding track.

The elastic mechanism, according to an aspect of the present invention, is installed on the interior surface of the left and right side walls of the magazine, besides, the elastic mechanism at least includes a plurality of elastic protruding tab that are installed on the position respectively corresponding to the plurality of disk holding members. Each of the plurality of elastic protruding tab extends from the interior surface of the side wall of the magazine inwardly toward the center of the magazine. The plurality of elastic protruding tab elastically clamps the left and right edges of the predetermined disk holding member when the predetermined disk holding member enter the guiding tract of the magazine. In addition, both the left and right edges on each one of the disk holding member are respectively installed with a positioning recess, such that one of the plurality of elastic protruding tab fit into the positioning recess when corresponding disk holding member have entirely entered into the magazine.

The elastic mechanism, according to the other aspect of the present invention, includes a pair of elastic protruding tab that is correspondingly installed on the interior surface of the left and right sections of the guiding track. In addition, the pair of elastic protruding tab is installed extending from the surface of the left and right side walls of the guiding track inwardly toward the center of the optical pick-up unit. The pair of elastic protruding tab elastically pushes against the left and right edges of the predetermined disk holding member when the predetermined disk holding member is in the guiding track of the optical pick-up unit. Furthermore, both the left and right edges on each one of the disk holding member are respectively installed with a positioning recess, such that one of the plurality of elastic protruding tab fit into the positioning recess when corresponding disk holding member have entirely entered into the magazine.

The elastic mechanism, according to another aspect of the present invention, the elastic mechanism at least includes a plurality pairs of elastic protruding tab. One pair of the elastic protruding tab are correspondingly installed on one of the plurality of disk holding member on left and right edges of each disk holding member, each of the plurality pair of elastic protruding tab extends from the edge of the corresponding disk holding member outwardly toward side walls of the magazine. In addition, one of the plurality pairs of elastic protruding tab, which are respectively installed on the left and right edges of the predetermined disk holding member, elastically pushes against the left and right side walls of the magazine when the predetermined disk holding member is in the magazine. The pair of elastic protruding tab on the left and the right edge of the predetermined disk holding member elastically pushes against the interior surface of the left and the right side wall of the optical pick-up unit when the predetermined disk holding member is in the guiding track of the optical pick-up unit. The interior surface of both the left and right sections of the part of the guiding track that within the magazine are respectively installed with one positioning recess such that one of the plurality of elastic protruding tab fit into the positioning recess when corresponding disk holding member having entirely entered into the magazine. In addition, the interior surface of both the left and right sections of the portion of the guiding track within the optical pick-up unit are respectively installed with one positioning recess, such that one of the plurality of elastic protruding tab fit into the positioning recess when corresponding disk holding member have entirely entered into the optical pick-up unit.

Because the disk changer utilize the fastening mechanism according to the preferred embodiments of the present invention, no matter the disk holding member is stationary or in motion, the elastic mechanism on the left and right sections of the guiding track makes the disk holding member firmly held, i.e., prevents the disk holding member from shocking. In addition, the installation of positioning recess enables the elastic protruding tab to fit into the positioning recess. Thus ensuring the disk holding member fixed in the predetermined position when the disk holding member enter into the magazine or optical pick-up unit.

### BRIEF DESCRIPTION OF THE DRAWINGS

The present invention will now be specified with reference to its preferred embodiment illustrated in the drawings, in which:

FIG. 1 schematically illustrates the isometric view of a disk changer in the prior art;

FIG. 2 is a top view of a disk changer according to one preferred embodiment of the present invention, which schematically illustrates the movement of a disk holding member;

FIG. 3 is a schematically perceptive side view of a disk changer in according to one preferred embodiment of the present invention, which schematically illustrates the guiding track with respective to the movement of a disk holding member;

FIG. 4 is the isometric view of the disk changer, which schematically illustrates the magazine and the plurality of disk holding members according to one preferred embodiment of the present invention;

FIG. 5 is the isometric view of the magazine of the disk changer, which schematically illustrates several partial views of the elastic mechanism according to one preferred embodiment of the present invention;

FIG. 6 is the isometric view of the handling mechanism of the disk changer, which schematically illustrates a partial view from top of the elastic mechanism, and a partial sectional view of the optical pick-up unit, the guiding track, the disk holding member, and the elastic mechanism according to the other preferred embodiment of the present invention;

FIG. 7 schematically illustrates the top view of the magazine, the optical pick-up unit, and the disk holding member (including elastic protruding tab and positioning recess) of the disk changer according to the preferred embodiment of the present invention; and

FIG. 8 schematically illustrates the top view of the disk holding member, the elastic protruding tab, and the elastic protruding tab according to the preferred embodiment of the present invention.

### DESCRIPTION OF THE PREFERRED EMBODIMENT

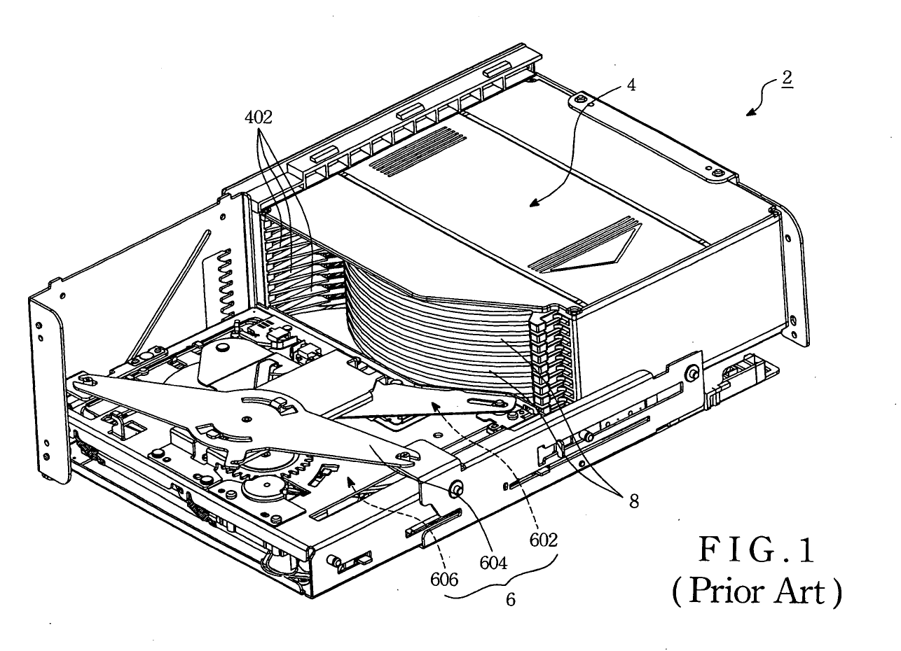

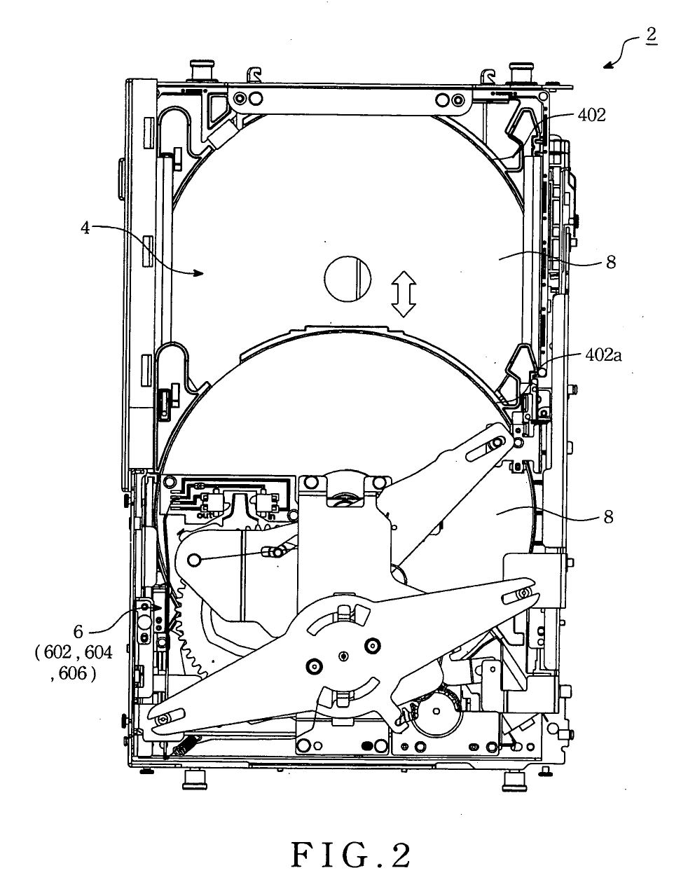

In view of FIG. 1, please refer to FIG. 2, the top view of the disk changer according to one preferred embodiment of the present invention is schematically illustrated, wherein the movement of the disk holding member driven by the handling mechanism is also illustrated. The fastening mechanism in the present invention is utilized in the disk changer 2 that is composed of a magazine 4 and a handling mechanism 6. The magazine 4 at least includes a plurality of disk holding member 402, and the handling mechanism 6 includes a drafting unit 602, a elevating unit 604, and a optical pick-up unit 606.

The three units mentioned above are mechanically coupled, in detail, the elevating unit 604 are loaded with the drafting unit 602 and the optical pick-up unit 606. The elevating unit 604 is used to vertically drive the other two unit of the processing mechanism 6. When the elevating unit 604 vertically moves to a predetermined position responding to one of the plurality of disk holding member 402, then the drafting unit 602 horizontally drafts the predetermined disk holding member 402a to a position corresponding to the optical pick-up unit 606, and the disk 8 on the predetermined disk holding member 402 is ready to be accessed by the optical pick-up unit 606. Specifically, when the predetermined disk holding member 402 is driven by the drafting unit 602, the right and/or left edge of the predetermined disk holding member 402a is adopted in and confined to move within the track of the magazine 4 and the optical pick-up unit 606, which is referred to as guiding track.

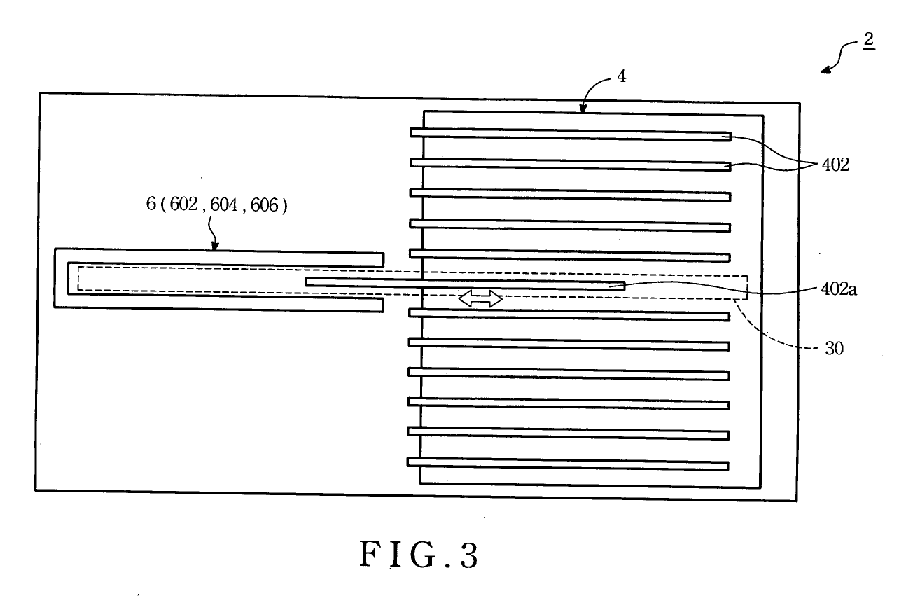

Please refer to FIG. 3, it schematically illustrates the side view of the guiding track 30 adopting the predetermined disk holding member 402a that is driven to slide by the drafting unit 602 (FIG. 2). As shown in FIG. 3, the guiding track 30, within which the predetermined disk holding member 402a can slide, has a portion formed in the magazine 4, and the other portion formed in the optical pick-up unit 606.

The fastening mechanism according to the preferred embodiment of the present invention at least includes an elastic mechanism which can be installed in the guiding track. When the predetermined disk holding member 402a slides or rests within the guiding track, the elastic mechanism is built to elastically clamp the right and/or left edge of the predetermined disk holding member 402a. Thus the fastening mechanism (elastic mechanism) according to the preferred embodiment of the present invention can elastically fasten the predetermined disk holding member, and prevent the it from shocking. The position of installation of the fastening mechanism (elastic mechanism) and its embodiment are detailed in the following description.

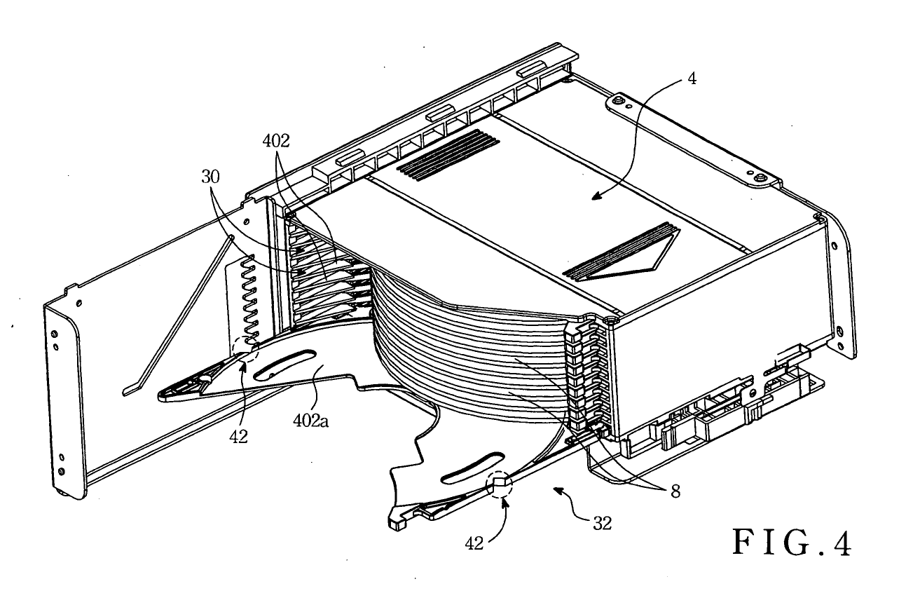

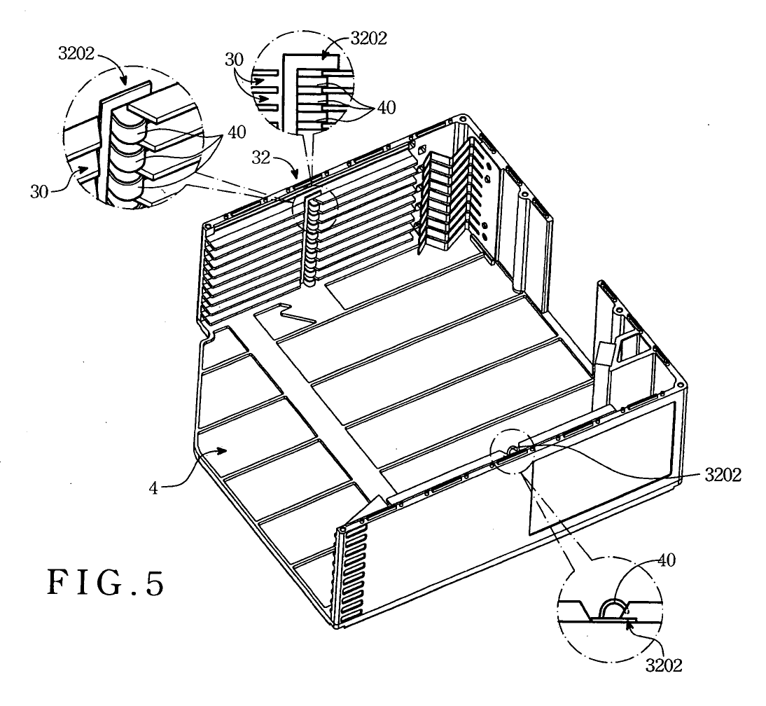

FIG. 4 is the isometric view of the disk changer, which schematically illustrates the magazine and the plurality of disk holding members according to one preferred embodiment of the present invention. FIG. 5 is the isometric view of the magazine of the disk changer, which schematically illustrates several partial views of the elastic mechanism according to one preferred embodiment of the present invention. In view of FIG. 4, please refer to FIG. 5, with the following description, the present invention can be understood better.

In one preferred embodiment of the present invention, the elastic mechanism includes strip members that are installed on both left and right side interior surface of the magazine 4, each of the strip member includes a plurality of elastic protruding tab 40 that extending inwardly toward the interior of the magazine 4, besides, each of the plurality of elastic protruding tab 40 is installed corresponding to the position of each of the plurality of the disk holding member 402. Either the predetermined disk holding member 402a moves or rests in the guiding track 30, one corresponding elastic protruding tab 40 of the elastic mechanism 3202 on each side of the magazine 4 will clamp the predetermined disk holding member 402a to prevent it from shocking.

From the foregoing description, in the preferred embodiment of the present invention, as shown in FIG. 5, there are two elastic mechanism 3202 symmetrically installed on opposite interior side-wall of the magazine 4. However, according to the present invention, the foregoing installation is not the only embodiment, more or less elastic mechanism 3202 can be installed either symmetrically or non-symmetrically, as long as the installation of the elastic mechanism 3202 can fasten the disk holding member, the installation of elastic mechanism 3202 is encompassed by the scope of the present invention.

In further detail, when the predetermined disk holding member 402a enter the magazine 4, because each of the plurality of disk holding member 402 includes two positioning recess 42 respectively installed on the left and right edges of the disk holding member 402 to the position matching the corresponding elastic protruding tab 40. Thus each of the plurality of disk holding member 402 can be firmly held in the magazine 4, and the corresponding pair of elastic protruding tabs 40 can firmly grab as well as prevent the predetermined disk holding member 402a from shaking. Accordingly, the fastening mechanism 32 in one preferred embodiment of the present invention includes the positioning recess 42 and the elastic mechanism 3202.

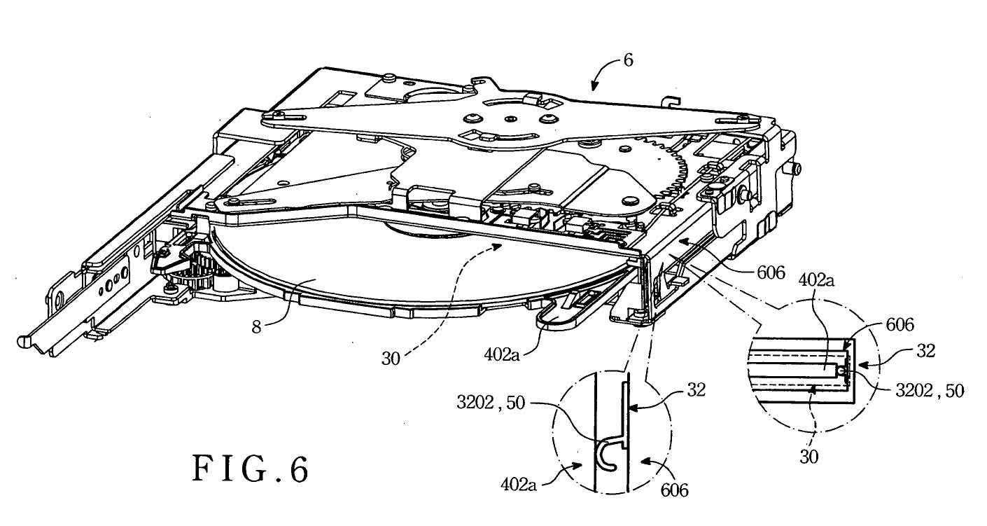

In view of FIG. 4, please turn to FIG. 6, in which the elastic mechanism 3202 according to the other embodiment of the present invention is illustrated, and the spatial relationship between the optical pick-up unit 606 and the elastic mechanism 3202 are also schematically illustrated. As described in the foregoing description about the fastening mechanism 32, its plurality of elastic protruding tabs 50 can be formed of elastic tabs, but in this embodiment, are installed on the interior surface of the guiding track 30 adjacent to the optical pick-up unit 606, wherein the shape of the elastic mechanism 3202 extends from the interior surface of the guiding track 30 toward the internal of the optical pick-up unit 606. In the other embodiment of the present invention, when the predetermined disk holding member 402a enter or rest in the guiding track 30 of the optical pick-up unit 606, the corresponding pair of elastic protruding tabs 50 in the guiding track 30 of the optical pick-up unit 606 are used to elastically grab the predetermined disk holding member 402a from both left and left edges of the predetermined disk holding member 402a. Thus the predetermined disk holding member 402a is firmly held in the each of the plurality of disk holding member 402 can be firmly held within the optical pick-up unit 606 without shocking.

In further detail, when each of the disk holding member 402 enters the optical pick-up unit 606 through guiding track 30, please refer to FIG. 6, the elastic protruding tabs 50 will fit into the positioning recess 42, therefore firmly fasten the disk holding member 402 on the position within the optical pick-up unit 606.

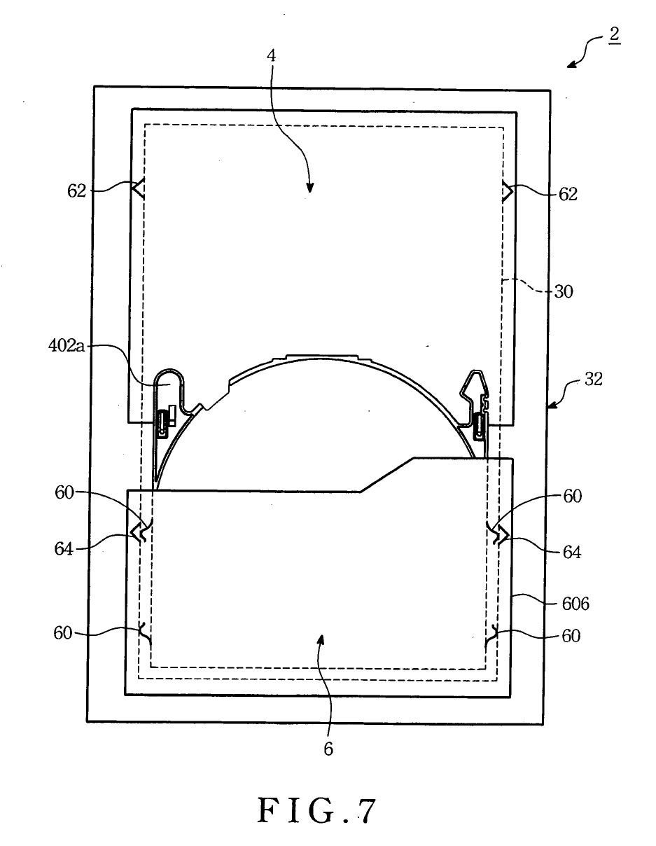

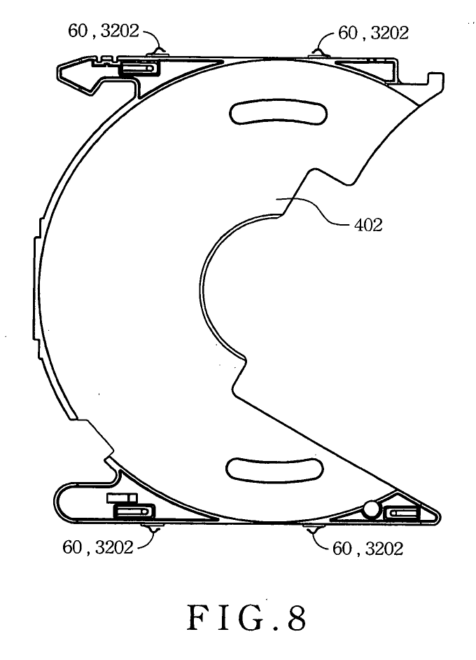

In another embodiment of the present invention, the installation of the elastic mechanism 3202 and the disk holding member 402 is described by referring to FIG. 8 in view of FIG. 7. As shown in FIG. 7, the spatial relationship between the magazine 4, the optical pick-up unit 606 and the disk holding member 402 are schematically illustrated in a top view. In addition, FIG. 8 schematically illustrates the disk holding member 402 and the elastic mechanism 3202 from a top view.

The fastening mechanism 32, in another embodiment of the present invention, is composed of several pairs of elastic protruding tabs 60, each pair of them are installed respectively on left and right edge of the disk holding member 402. In addition, each one of the pair of elastic protruding tab 60 are respectively installed on the left and right edge of the disk holding member 402, and formed in a shape extending to the left and right interior side walls of the disk changer 2 (FIG. 7). There are two pairs of elastic protruding tab 60, as shown in FIG. 8, installed on left and right edges of the disk holding member 402.

When the predetermined disk holding member 402a moves or rests in the guiding track 30 within the magazine 4, the elastic protruding tab 60 is used to elastically push against the left and right interior side walls of the magazine 4, i.e., push against the interior surface on both left and right section of the guiding track 30 as shown in FIG. 7. When the predetermined disk holding member 402a enter or rest in the guiding track 30 of the optical pick-up unit 606, the corresponding pair of elastic protruding tabs 60 at the left and right edges of the predetermined disk holding member 402a elastically push against the interior surface of the left and right sections of the guiding track 30 within the optical pick-up unit 606.

In addition, the interior surface of either the left or right section of the guiding tract 30 within the magazine 4 includes a positioning recess 62 installed on the position that matching an elastic protruding tab 60 when the corresponding disk holding member 402 enters the magazine 4. Thus each of the plurality of disk holding member 402 (certainly including the predetermined disk holding member 402a) can be firmly held in the magazine 4, because the corresponding pair of elastic protruding tabs 60 fit into its' corresponding positioning recess, thereby firmly grab the predetermined disk holding member 402a and prevent it from shaking.

Meanwhile, in the other aspect of another preferred embodiment of the present invention, there are two additional positioning recess 64 respectively installed on a position of the left and right section of the guiding track 30 within the optical pick-up unit 606, such that the elastic protruding tabs 60 respectively fit into the positioning recesses 60 when the predetermined disk holding member 402a entirely enter the optical pick-up unit 606. In other words, each one of the disk holding member 402, such as the predetermined disk holding member 402a can be firmly held in the optical pick-up unit 606 by the elastic mechanism 3202 and its' corresponding positioning recess 60.

Accordingly, the present invention can be utilized in a magazine 4 of a disk changer 2, in which the installation of the elastic mechanism 3202 on both left and right section of the guiding track 30 enables the disk holding member 402 to be held firmly within the disk changer without shocking no matter the disk holding member is moving or stationary. In addition, the using of positioning recess 42, 62 and 64 in combination respectively with the elastic protruding tab 40, 50 and 60 enables the disk holding member 402 be firmly held within the magazine 4 or within the optical pick-up unit 606 at predetermined position.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A disk changer device comprising:
a magazine comprising a plurality of disk holding member, and
a handling mechanism comprising:
a drafting unit being used to horizontally draft a predetermined disk holding member to a position corresponding to said optical pick-up unit;
an elevating unit being loaded with said drafting unit and said optical pick-up unit, said elevating unit being used to vertically move said drafting unit and said optical pick-up unit to a predetermined position corresponding to said predetermined disk holding member of the plurality of disk holding member; and
an optical pick-up unit for accessing a disk on said predetermined disk holding member, wherein said predetermined disk holding member being draft following a guiding track; and
at least one elastic mechanism installed on left and right section of said guiding track, wherein said elastic mechanism elastically push against corresponding right and left edge of said predetermined disk holding member as long as said predetermined disk holding member being within said guiding track.

2. The disk changer device as claim 1, wherein said guiding track is installed within said magazine and said optical pick-up unit.

3. The disk changer device as claim 1, wherein said elastic mechanism is installed on the interior surface of the left and right side walls of said magazine, said elastic mechanism comprising a plurality of elastic protruding tab respectively installed on a position corresponding to said plurality of disk holding members, each of said plurality of elastic protruding tab extending from the interior surface of the side wall of said magazine toward center of the magazine, said plurality of elastic protruding tab elastically clamping left and right edges of said predetermined disk holding member when said predetermined disk holding member entering said guiding tract within said magazine.

4. The disk changer device as claim 3, wherein both left and right edges of each of said disk holding member are respectively installed with one positioning recess such that one of said plurality of elastic protruding tab fit into said positioning recess when corresponding disk holding member having entirely entered into said magazine.

5. The disk changer device as claim 1, wherein said elastic mechanism comprises a pair of elastic protruding tab, said pair of elastic protruding tab being correspondingly installed on interior surface of left and right sections of said guiding track within said optical pick-up unit, said pair of elastic protruding tab extending from the interior surface of said guiding track of said optical pick-up unit inwardly toward center of said optical pick-up unit, said pair of elastic protruding tab elastically pushing against left and right edges of said predetermined disk holding member when said predetermined disk holding member being in said guiding track of said optical pick-up unit.

6. The disk changer device as claim 5, wherein both the left and right edges of each of said disk holding member are respectively installed with one positioning recess such that one of said plurality of elastic protruding tab fit into said positioning recess when corresponding disk holding member has entirely entered into said magazine.

7. The disk changer device as claim 1, wherein said elastic mechanism comprises a plurality pairs of elastic protruding tab, each pair of said elastic protruding tab correspondingly installed on each of said plurality of disk holding member separately on left and right edges of each disk holding member, each of said plurality of elastic protruding tab extending from the edge of each of said plurality of disk holding member outwardly toward side walls of said magazine, one pair of said plurality of elastic protruding tab, which are respectively installed on left and right edges of said predetermined disk holding member, elastically pushing against left and right side walls of said magazine when said predetermined disk holding member being in said magazine, said pair of elastic protruding tab on left and right edges of said predetermined disk holding member elastically pushing against interior surface of left and right side walls of said optical pick-up unit when said predetermined disk holding member being in said guiding track of said optical pick-up unit.

8. The disk changer device as claim 7, wherein interior surface of both the left and right sections of said guiding track of said magazine are respectively installed with one positioning recess such that one of said plurality of elastic protruding tab fits into said positioning recess when corresponding disk holding member has entirely entered into said magazine.

9. The disk changer device as claim 7, wherein interior surface of both the left and right sections of said guiding track of said optical pick-up unit are respectively installed with one positioning recess such that one of said plurality of elastic protruding tab fits into said positioning recess when corresponding disk holding member having entirely entered into said optical pick-up unit.

10. A fastening mechanism utilized in a disk changer, said disk changer comprising:
a magazine comprising a plurality of disk holding member; and
a handling mechanism comprising:
a drafting unit being used to horizontally draft a predetermined disk holding member to a position corresponding to said optical pick-up unit;
an elevating unit being loaded with said drafting unit and said optical pick-up unit, said elevating unit being used to vertically move said drafting unit and said optical pick-up unit to a predetermined position corresponding to said predetermined disk holding member of the plurality of disk holding member; and
an optical pick-up unit for accessing a disk on said predetermined disk holding member, wherein said predetermined disk holding member being draft following a guiding track; and
at least one elastic mechanism installed on left and right section of said guiding track, wherein said elastic mechanism elastically push against corresponding right and left edge of said predetermined disk holding member as long as said predetermined disk holding member being within said guiding track.

11. The fastening mechanism as claim 10, wherein said guiding track is installed within said magazine and said optical pick-up unit.

12. The fastening mechanism as claim 10, wherein said elastic mechanism is installed on the interior surface of the left and right side walls of said magazine, said elastic mechanism comprising a plurality of elastic protruding tab respectively installed on a position corresponding to said plurality of disk holding members, each of said plurality of elastic protruding tab extending from the interior surface of the side wall of said magazine toward center of the magazine, said plurality of elastic protruding tab elastically clamping left and right edges of said predetermined disk holding member when said predetermined disk holding member entering said guiding tract within said magazine.

13. The fastening mechanism as claim 12, wherein both left and right edges of each of said disk holding member are respectively installed with one positioning recess such that one of said plurality of elastic protruding tab fits into said positioning recess when corresponding disk holding member has entirely entered into said magazine.

14. The disk changer device as claim 10, wherein said elastic mechanism comprises a pair of elastic protruding tab, said pair of elastic protruding tab being correspondingly installed on interior surface of left and right sections of said guiding track within said magazine, said pair of elastic protruding tab extending from the interior surface of said guiding track of said magazine inwardly toward center of said optical pick-up unit, said pair of elastic protruding tab elastically pushing against left and right edges of said predetermined disk holding member when said predetermined disk holding member being in said guiding track of said optical pick-up unit.

15. The fastening mechanism as claim 14, wherein both the left and right edges of each of said disk holding member are respectively installed with one positioning recess such that one of said plurality of elastic protruding tab fit into said positioning recess when corresponding disk holding member having entirely entered into said magazine.

16. The fastening mechanism as claim 10, wherein said elastic mechanism comprises a plurality pairs of elastic protruding tab, each pair of said elastic protruding tab correspondingly installed on each of said plurality of disk holding member separately on left and right edges of each disk holding member, each of said plurality of elastic protruding tab extending from the edge of each of said plurality of disk holding member outwardly toward side walls of said magazine, one pair of said plurality of elastic protruding tab, which respectively installed on left and right edges of said predetermined disk holding member, elastically pushing against left and right side walls of said magazine when said predetermined disk holding member being in said magazine, said pair of elastic protruding tab on left and right edges of said predetermined disk holding member elastically pushing against interior surface of left and right side walls of said optical pick-up unit when said predetermined disk holding member being in said guiding track of said optical pick-up unit.

17. The fastening mechanism as claim 16, wherein interior surface of both the left and right sections of said guiding track of said magazine are respectively installed with one positioning recess such that one of said plurality of elastic protruding tab fits into said positioning recess when corresponding disk holding member has entirely entered into said magazine.

18. The fastening mechanism as claim 16, wherein interior surface of both the left and right sections of said guiding track of said optical pick-up unit are respectively installed with one positioning recess such that one of said plurality of elastic protruding tab fits into said positioning recess when corresponding disk holding member has entirely entered into said optical pick-up unit.

19. A disk changer device comprising:
a magazine comprising a plurality of disk holding member; and
a handling mechanism comprising:
a drafting unit being used to horizontally draft a predetermined disk holding member to a position corresponding to said optical pick-up unit;
an elevating unit being loaded with said drafting unit and said optical pick-up unit, said elevating unit being used to vertically move said drafting unit and said optical pick-up unit to a predetermined position corresponding to said predetermined disk holding member of the plurality of disk holding member; and
an optical pick-up unit for accessing a disk on said predetermined disk holding member, wherein said predetermined disk holding member being draft following a guiding track; and
at least one elastic mechanism installed on left and right edges of each of said plurality of disk holding member, said elastic mechanism extending outwardly toward side walls of said magazine.

20. The disk changer device as claim 19, wherein said elastic mechanism comprises a plurality pairs of elastic protruding tab, one pair of said plurality of elastic protruding tab, which is respectively installed on left and right edges of said predetermined disk holding member, and elastically pushes against left and right side walls of said magazine when said predetermined disk holding member is in said magazine, said pair of elastic protruding tab on left and right edges of said predetermined disk holding member elastically pushing against interior surface of left and right side walls of said optical pick-up unit when said predetermined disk holding member being in said guiding track of said optical pick-up unit.
